(19) United States
(12) Patent Application Publication
(10) Pub. No.: US 2026/0322454 A1
(43) Pub. Date: Oct. 15, 2026

(54) DETERMINING CPU USAGE FOR A CSI REPORT WITH TIME DOMAIN CHANNEL PROPERTIES

(71) Applicant: Telefonaktiebolaget LM Ericsson (publ), Stockholm (SE)

(72) Inventors: Siva Muruganathan, Stittsville (CA); Shiwei Gao, Nepean (CA); Per Ernström, Stockholm (SE)

(21) Appl. No.: 19/483,749

(22) PCT Filed: May 13, 2024
(86) PCT No.: PCT/IB2024/054652

§ 371 Date: Nov. 12, 2025

Related U.S. Application Data
(60) Provisional application No. 63/466,068, filed on May 12, 2023.

(51) Int. Cl. H04B 7/06

(52) U.S. Cl. CPC H04B 7/0626

(57) ABSTRACT

Systems and methods for determining a total number of Channel State Information (CSI) Processing Units (CPUs) for a report are provided. In some embodiments, a number of resource sets and of resources per set are determined. A number of autocorrelation delays up to which to report and/or a number of CPUs for the report is determined. In some embodiments, the whether the User Equipment (UE) has enough CPUs to process a Time Domain Channel Property (TDCP) report is determined. For a given maximum number of CPUs, both the gNB and the UE determine whether the UE has enough CPUs to process a TDCP report. This makes it possible to design a less complex UE. This puts a limit on the required CPU capabilities of the UE and thus makes it possible to dimension the UE processing power accordingly rather than to over-dimension the UE for the worst-case CPU load.

### RELATED APPLICATIONS

This application claims the benefit of provisional patent application Ser. No. 63/466,068, filed May 12, 2023, the disclosure of which is hereby incorporated herein by reference in its entirety.

### BACKGROUND

### Channel State Information Reference Signals (CSI-RS)

For CSI measurement and feedback, CSI-RS are defined. A CSI-RS is transmitted on each antenna port and is used by a UE to measure a downlink channel between each of the transmit antenna ports and each of its receive antenna ports. The transmit antenna ports are also referred to as CSI-RS ports. The supported number of antenna ports in NR are {1, 2, 4, 8, 12, 16, 24, 32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain REs in a slot and certain slots. FIG. 1 shows an example of CSI-RS REs for 12 antenna ports, where 1 RE per RB per port is shown.

In addition, Interference Measurement Resource (IMR) is also defined in NR for a UE to measure interference. An IMR resource contains 4 REs, either 4 adjacent REs in frequency in the same OFDM symbol or 2 by 2 adjacent REs in both time and frequency in a slot. By measuring both the channel based on NZP CSI-RS and the interference based on an IMR, a UE can estimate the effective channel and noise plus interference to determine the CSI, i.e., rank, precoding matrix, and the channel quality.

Furthermore, a UE in NR may be configured to measure interference based on one or multiple NZP CSI-RS resource.

### TRS

Due to oscillator imperfections, transmission and reception may not be synchronized in time and/or frequency, which can cause inter- and intra-symbol interference. In NR, Tracking Reference Signal (TRS) was introduced that can be used by the UE for fine time/frequency synchronization.

In NR 3GPP specifications, TRS can be configured when CSI report setting is not configured or when the higher layer parameter ‘reportQuantity’ in the CSI-ReportConfig information element (IE), associated with all the report settings linked with the CSI-RS resource set containing the TRS(s) is set to ‘none’. This means that CSI reporting based on measurements on TRS is not supported in NR.

TRS is configured via ‘trs-Info’ in the NZP-CSI-RS-ResourceSet IE of 3GPP TS 38.331 which is associated with a CSI-RS resource set, for which the UE can assume that the antenna port with the same port index of the configured NZP CSI-RS resources in the said resource set is the same. From 3GPP specifications perspective TRS is specified as a special kind of NZP CSI-RS where the corresponding NZP CSI-RS resource set containing the TRS(s) has a higher layer parameter ‘trs-info’ set to true.

TRS is not really a CSI-RS, rather it is a resource set consisting of multiple periodic NZP CSI-RS. More specifically, a TRS consists of four one-port, density-3 CSI-RSs located within two consecutive slots. The CSI-RS within the said resource set, can be configured with a periodicity of 10, 20, 40, or 80 ms. Note that the exact set of REs used for the TRS CSI-RS may vary. There is always a four-symbol time-domain separation between the two CSI-RS within a slot. FIG. 2 shows an example of a periodic TRS, where TRS locations within two consecutive slots are shown. The TRS in the two slots are also referred to a TRS burst. NR also supports aperiodic TRS.

### CSI Framework in NR

In NR, a UE can be configured with multiple CSI reporting settings and multiple CSI-RS resource settings. Each resource setting can contain multiple resource sets, and each resource set can contain up to 8 CSI-RS resources. For each CSI reporting setting, a UE feeds back a CSI report.

Each CSI reporting setting contains at least the following information:
A CSI-RS resource set for channel measurement
An IMR resource set for interference measurement
Optionally, a CSI-RS resource set for interference measurement
Time-domain behavior, i.e., periodic, semi-persistent, or aperiodic reporting
Frequency granularity, i.e., wideband or subband
CSI parameters to be reported such as RI, PMI, CQI, and CSI-RS resource indicator (CRI) in case of multiple CSI-RS resources in a resource set
Codebook types, i.e., Type I or II, and codebook subset restriction
Measurement restriction
Subband size. One out of two possible subband sizes is indicated, the value range depends on the bandwidth of the BWP. One CQI/PMI (if configured for subband reporting) is fed back per subband).

In NR, CSI-AperiodicTriggerState is configured in order to trigger aperiodic CSI reports. The CSI-AperiodicTriggerList IE is defined in 3GPP TS 38.331 V17.2.0 as follows:

There is list of trigger states which may include up to 128 of CSI-AperiodicTriggerStates. Each trigger state may include up to 16 CSI-AssociatedReportConfigInfo. Each CSI-AssociatedReportConfigInfo contains a reportconfig id which associates it to a CSI-Reportconfig. UE may have up to 48 different reportconfigs configured. Each Reportconfig includes codebookConfig as a field.

### CSI Processing Criteria

In NR, a UE indicates the number of supported simultaneous CSI calculations, N_{CPU}, with parameter simultaneousCSI-ReportsPerCC in a component carrier (CC), and simultaneousCSI-ReportsAllCC across all CCs. If a UE supports N_{CPU} simultaneous CSI calculations it is said to have N_{CPU} CSI processing units for processing CSI reports. If L CPUs are occupied for calculation of CSI reports in a given OFDM symbol, the UE has N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to

$${O}_{CPU}^{( n )}$$

CPUs, the UE is not required to update the N−M requested CSI reports with lowest priority (according to Clause 5.2.5 of 3GPP 38.214), where 0≤M≤N is the largest value such that

$${\sum }_{n = 0}^{M - 1} {O}_{CPU}^{( n )} \leq {N}_{CPU} - L$$

holds.

A UE is not expected to be configured with an aperiodic CSI trigger state containing more than N_{CPU} Reporting Settings. Processing of a CSI report occupies a number of CPUs, O_{CPU}, for a number of symbols as follows according 3GPP 38.214:
O_{CPU}=0 for a CSI report with CSI-ReportConfig with higher layer parameter reportQuantity set to ‘none’ and CSI-RS-ResourceSet with higher layer parameter trs-Info configured
O_{CPU}=1 for a CSI report with CSI-ReportConfig with higher layer parameter reportQuantity set to ‘cri-RSRP’, ‘ssb-Index-RSRP’, ‘cri-SINR’, ‘ssb-Index-SINR’, ‘cri-RSRP-Index’, ‘ssb-Index-RSRP-Index’, ‘cri-SINR-Index’, ‘ssb-Index-SINR-Index’ or ‘none’ (and CSI-RS-ResourceSet with higher layer parameter trs-Info not configured)
for a CSI report with CSI-ReportConfig with higher layer parameter reportQuantity set to ‘cri-RI-PMI-CQI’, ‘cri-RI-i1’, ‘cri-RI-i1-CQI’, ‘cri-RI-CQI’, or ‘cri-RI-LI-PMI-CQI’,
   O_{CPU}=N_{CPU} if max{μ_{PDCCH}, μ_{CSI-RS}, μ_{UL}}≤3, and if a CSI report is aperiodically triggered without transmitting a PUSCH with either transport block or HARQ-ACK or both when L=0 CPUs are occupied, where the CSI corresponds to a single CSI with wideband frequency-granularity and to at most 4 CSI-RS ports in a single resource without CRI report and where codebookType is set to ‘typeI-SinglePanel’ or where reportQuantity is set to ‘cri-RI-CQI’,
   O_{CPU}=X·N+M If a CSI-ReportConfig is configured with codebookType set to ‘typeI-SinglePanel’ and the corresponding CSI-RS Resource Set for channel measurement is configured with two Resource Groups and N Resource Pairs, where X is the number of CPUs occupied by a pair of CMRs subject to UE capability given by mTRP-CSI-numCPU-r17 and M is defined in clause 5.2.1.4.2 of 3GPP 38.214 v17.5.0
   O_{CPU}=Kₛ otherwise, where Kₛ is the number of CSI-RS resources in the CSI-RS resource set for channel measurement.

For a CSI report with CSI-ReportConfig with higher layer parameter reportQuantity not set to ‘none’, the CPU(s) are occupied for a number of OFDM symbols as follows:
A periodic or semi-persistent CSI report (excluding an initial semi-persistent CSI report on PUSCH after the PDCCH triggering the report) occupies CPU(s) from the first symbol of the earliest CSI-RS/CSI-IM/SSB resource in a CSI resource set for channel or interference measurement in a latest CSI-RS/CSI-IM/SSB occasion no later than the corresponding CSI reference resource, until the last symbol of the configured PUSCH/PUCCH carrying the report.
An aperiodic CSI report occupies CPU(s) from the first symbol after the PDCCH triggering the CSI report until the last symbol of the scheduled PUSCH carrying the report. When the PDCCH reception includes two PDCCH candidates from two respective search space sets, as described in clause 10.1 of 3GPP TS 38.213, for the purpose of determining the CPU occupation duration, the PDCCH candidate that ends later in time is used.
An initial semi-persistent CSI report on PUSCH after the PDCCH trigger occupies CPU(s) from the first symbol after the PDCCH until the last symbol of the scheduled PUSCH carrying the report. When the PDCCH reception includes two PDCCH candidates from two respective search space sets, as described in clause 10.1 of 3GPP TS 38.213, for the purpose of determining the CPU occupation duration, the PDCCH candidate that ends later in time is used.

### Rel-18 TRS Based TDCP Reporting

It has been agreed that TRS based TDCP (time domain channel properties) reporting will be supported in NR Rel-18.

There are several use cases for the gNB to know the time domain channel properties (TDCP) based on TRS measurements. One use case for TDCP reporting is to enable the gNB to select a transmission scheme that is more robust to channel ageing when the channel varies fast. For instance, based on the TRS-based TDCP reported by the UE to the gNB, the gNB may need to decide whether the precoder for the UE should be based on CSI obtained from uplink measurements or from CSI feedback obtained from the UE. Another example is that the gNB may need to decide whether the precoder to schedule the UE should be based on Type I CSI feedback (as specified in 3GPP TS 38.214) obtained from the UE or Type II CSI feedback (as specified in 3GPP TS 38.214) obtained from the UE.

UE measurement and reporting of time domain correlation based on TRS samples across different time lags is an efficient way to report TDCP based on TRS.

In order to define the time domain correlation measurement across TRS samples, let Xₗ[n], n=0, 1, . . . , N−1 be the received frequency domain TRS samples after matched filtering and after removing the reference signal sequence. Index l denotes the different OFDM symbols carrying the TRSs used for the correlation estimation. Note that the TRSs used for the correlation estimation may be located in the same or different slots. The starting point in time of the OFDM symbol l is given by tₗ (to be precise tₗ denotes the start of the non-CP part of the OFDM symbol). Index n denote TRS sample index (assumed to be proportional to subcarrier index).

Let Pₘ(u), m=1 . . . M, u=1, 2 be the l-indices of M symbol pairs to use for the estimation of the correlation for a delay τ=t_{P}_{ₘ}₍₂₎−t_{P}_{ₘ}₍₁₎. It is assumed that the M symbol pairs are separated by the same distance in time.

In one example, a low-complexity estimate of the normalized time domain correlation for a delay τ is calculated in the frequency domain as:

$$ϕ ( τ ) = \frac{{\sum }_{m = 1}^{M} {\sum }_{n = 0}^{N - 1} {X}_{{P}_{m} ( 2 )} [ n ] \cdot {X}_{{P}_{m} ( 1 )}^{*} [ n ]}{\frac{1}{2} {\sum }_{m = 1}^{M} {\sum }_{n = 0}^{N - 1} ( {X}_{{P}_{m} ( 1 )} [ n ] \cdot {X}_{{P}_{m} ( 1 )}^{*} [ n ] + {X}_{{P}_{m} ( 2 )} [ n ] \cdot {X}_{{P}_{m} ( 2 )}^{*} [ n ] )} ,$$

In another example, the inverse DFT is calculated for each OFDM symbol l:

$${Y}_{l} [ k ] = ifft ( {X}_{l} [ n ] )$$

The estimate of the normalized correlation for time delay τ is calculated as

$${ϕ}^{Δ t} ( t , τ ) = \frac{{\sum }_{m = 1}^{M} {\sum }_{k ∈ Γ ( m )} {Y}_{{P}_{m} ( 2 )} [ k ] \cdot {Y}_{{P}_{m} ( 1 )}^{*} [ k ]}{\frac{1}{2} {\sum }_{m = 1}^{M} {\sum }_{k ∈ Γ ( m )} ( {Y}_{{P}_{m} ( 1 )} [ k ] \cdot {Y}_{{P}_{m} ( 1 )}^{*} [ k ] + {Y}_{{P}_{m} ( 2 )} [ k ] \cdot {Y}_{{P}_{m} ( 2 )}^{*} [ k ] )} ,$$

where the sum over time samples is over sets Γ(m) defined to suppress noise, e.g., by using a noise threshold such as e.g.

$$k ∈ Γ ( m ) ⟺ \{ \begin{matrix}\frac{\vert {Y}_{{P}_{m} ( 1 )} [ k ] \vert}{{σ}_{{P}_{m} ( 1 )}} > threshold \\ \frac{\vert {Y}_{{P}_{m} ( 2 )} [ k ] \vert}{{σ}_{{P}_{m} ( 2 )}} > threshold\end{matrix}$$

where σ_{P}_{ₘ}₍ᵢ₎ are noise estimates.

Note that at low speeds the change in the channel is small and the change in correlation at different delays within a TRS burst (i.e., within two slots) is quite small. Within a TRS burst, correlation can be measured for delays of 4 symbol, 10 symbol, 14 symbol, and 18 symbols as shown in FIG. 3.

FIG. 3 Delays τₖ for which the correlation can be estimated based on intra TRS burst measurements using the TRS signal.

As the change in correlation at different delays within a TRS burst is quite small for low velocities, intra TRS burst measurements are not enough to distinguish between different velocities in the low velocity region. Therefore, measuring and reporting correlation for time delays corresponding to multiple TRS bursts will also be supported in Rel-18. TDCP reporting up to four delays can be configured.

Note that up to NR Rel-17, no CSI is measured or reported based on TRS. Hence, the number of CPUs occupied for a CSI report associated with a CSI-RS ResourceSet with higher layer parameter trs-info configured is always zero.

Improved systems and methods for measuring CSI are needed.

### SUMMARY

Systems and methods for determining a total number of Channel State Information (CSI) Processing Units (CPUs) for a report are provided. In some embodiments, a number, K_{TRS}, of resource sets is determined; a number, N_{TRS}, of resources per resource set is determined; a number, Y, of autocorrelation delays up to which to report is determined; and/or a number, O_{CPU}, of CPUs for the report is determined. In some embodiments, the whether the UE has enough CPUs to process a Time Domain Channel Property (TDCP) report in a certain time duration is determined. For a given maximum number of CPUs supported by the UE, the method allows both the gNB and the UE to determine deterministically whether the UE has enough CPUs to process a TDCP report in a certain time duration. To have a limitation like this makes it possible to design a less complex UE. It puts a limit on the required CPU capabilities of the UE and thus makes it possible to dimension the UE processing power accordingly rather than to over-dimension the UE processing power for the worst-case CPU load.

In some embodiments, one or more of: the report comprises a TDCP report; the resource sets comprise Tracking Reference Signal (TRS) resource sets; and the resources comprise TRS resources.

In some embodiments, determining the number, O_{CPU}, of CPUs for the report comprises: O_{CPU}=X_{TDCP}Y+C, where X_{TDCP} is the number of CPUs required for each of the Y normalized wideband autocorrelation based TDCP computations.

In some embodiments, X_{TDCP} is reported by the UE. In some embodiments, the value of X_{TDCP} is a function of whether only the amplitude of the normalized wideband autocorrelation is requested to be reported or both the amplitude and the phase of the normalized wideband autocorrelation is requested to be reported. In some embodiments, C is an integer value that is reported by the UE.

In some embodiments, the method also includes determining a number, K_{TRS}, of resource sets; and determining a number, N_{TRS}, of resources per resource set. In some embodiments, determining the number, O_{CPU}, of CPUs for the report comprises: O_{CPU}=X′_{TDCP}K_{TRS}+C′, where X′_{TDCP} is the number of CPUs required for each of the K_{TRS} TRS resource sets. In some embodiments, determining the number, O_{CPU}, of CPUs for the report comprises: O_{CPU}=X″_{TDCP}N_{TRS}+C″, where X″_{TDCP} is the number of CPUs required for each of the N_{TRS} TRS resources per TRS resource set.

In some embodiments, the method also includes: determining whether the UE has enough CPUs to process a TDCP report in a certain time duration.

In some embodiments, the UE is configured to report normalized wideband autocorrelation based TDCP report for up to Y>=1 different delay values.

In some embodiments, X_{TDCP} is a function of any one or more of: the number of TRS resource sets; the number of TRS resources per TRS resource set; and the delay values associated with the TDCP computations. In some embodiments, O_{CPU}=1 if the Y normalized wideband autocorrelations are for delays within 2 slots regardless the value of Y.

In some embodiments, when periodic TRS resource sets are configured for TDCP measurement and report, the CPU(s) are occupied right after the TDCP report being configured until the TDCP report configuration is released. In some embodiments, the TDCP measurements are based on TRS resources. In some embodiments, the TDCP measurements are based on another type of reference signal.

In some embodiments, the number of resources per resource set N_{TRS} is replaced by the number of reference signals per resource set corresponding to the said type of reference signal. In some embodiments, the number of TRS resource sets K_{TRS} is replaced by the number of reference signals per resource set corresponding to the said type of reference signal.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of RE allocation for a 12-port CSI-RS in NR;

FIG. 2 illustrates an example of periodic TRS;

FIG. 3 illustrates delays Tk for which the correlation can be estimated based on intra TRS burst measurements using the TRS signal;

FIG. 4 illustrates method performed by a user equipment for determining a total number of CPUs for a report in accordance with some embodiments of the present disclosure;

FIG. 5 illustrates method performed by a network node for determining a total number of CPUs for a report in accordance with some embodiments of the present disclosure;

FIG. 6 illustrates an example illustrating the CPU duration for aperiodic CJT CSI report;

FIG. 7 shows an example of a communication system in accordance with some embodiments of the present disclosure;

FIG. 8 shows a User Equipment device (UE) in accordance with some embodiments of the present disclosure;

FIG. 9 shows a network node in accordance with some embodiments of the present disclosure;

FIG. 10 is a block diagram of a host, which may be an embodiment of the host of FIG. 7, in accordance with various aspects of the present disclosure described herein;

FIG. 11 is a block diagram illustrating a virtualization environment in which functions implemented by some embodiments of the present disclosure may be virtualized; and

FIG. 12 shows a communication diagram of a host communicating via a network node with a UE over a partially wireless connection in accordance with some embodiments of the present disclosure.

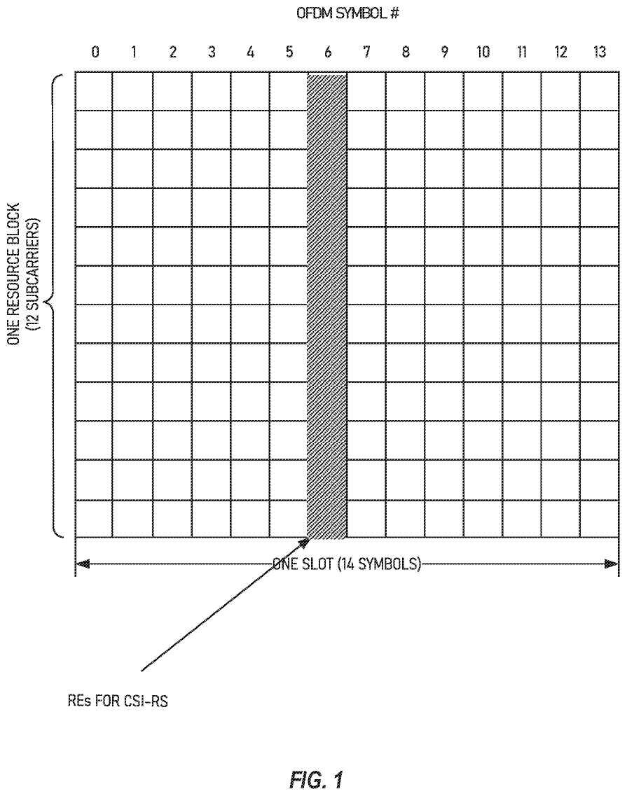

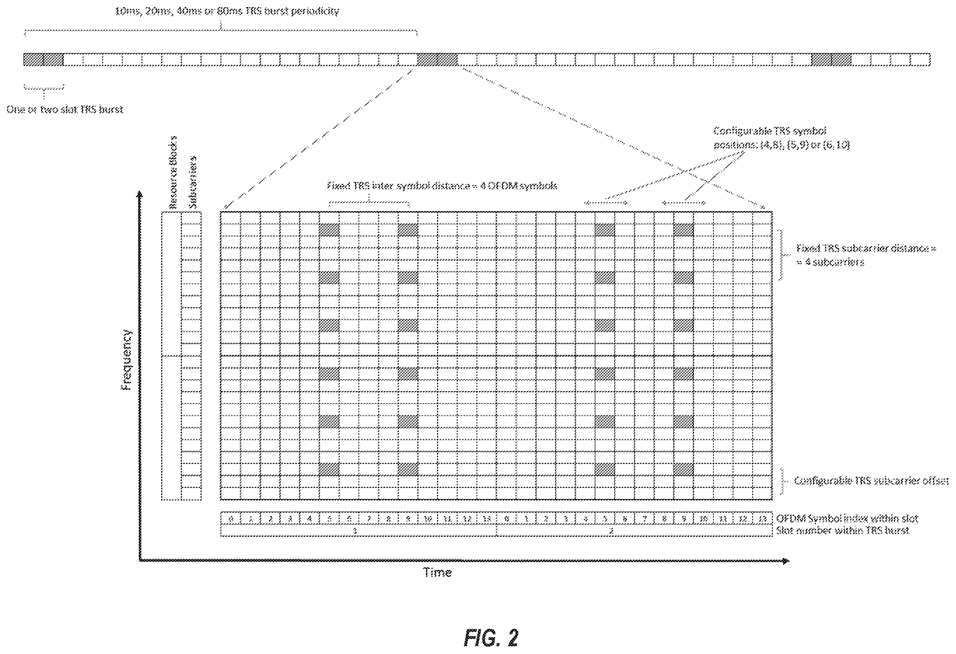

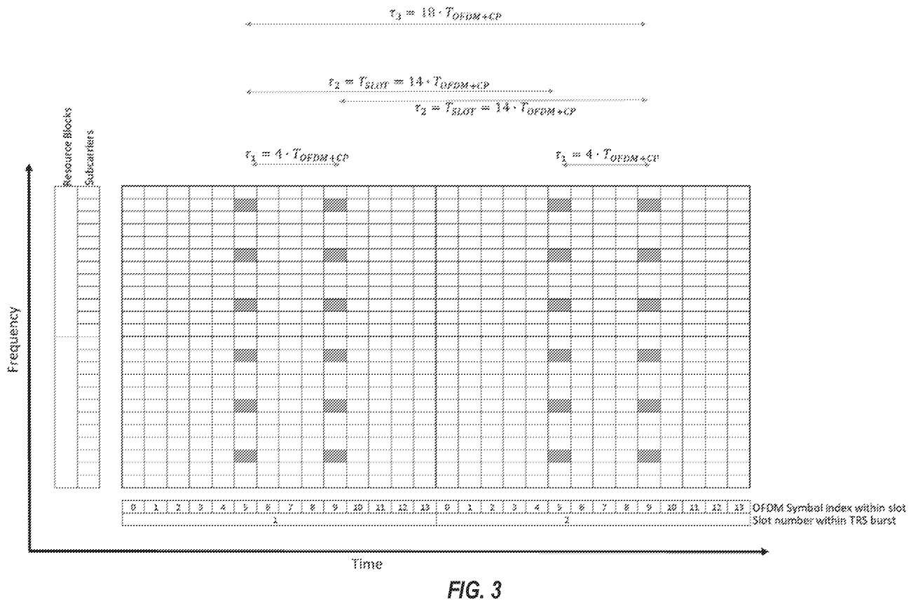

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

There currently exist certain challenge(s). Unlike existing specifications prior to NR Rel-18, when TDCP is reported based on measurements performed on TRS, the CSI framework is used. The TDCP report is essentially a kind of CSI report based on measurements performed on TRS. However, since TDCP is a wideband report and it involves measurements over two TRS symbols separated by a delay r, CPU occupation rules applicable to other type of CSI reports may not be valid. Hence, how to define CPU occupation rules for TDCP reporting is an open problem to solve.

Certain aspects of the disclosure and their embodiments may provide solutions to these or other challenges. A method is proposed for determining the number CPUs for a TDCP report configured with configured with K_{TRS} TRS resource sets, N_{TRS} TRS resources per TRS resource set, and reporting of TDCP for up to Y autocorrelation delays. Three different embodiments are disclosed for defining the number of occupied CPUs.

For a TDCP report configured with K_{TRS} TRS resource sets, N_{TRS} TRS resources per TRS resource set, and reporting of TDCP for up to Y autocorrelation delays, determining a total number of CPUs, O_{CPU}, for the CJT CSI report based on one of:
O_{CPU}=X_{TDCP}Y+C, where X_{TDCP} is the number of CPUs required for each of the Y normalized wideband autocorrelation based TDCP computations and it is either predetermined or reported by the UE; and C is an integer value that may be either pre-determined or reported by the UE
O_{CPU}=X′_{TDCP}K_{TRS}+C′, where X′_{TDCP} is the number of CPUs required for each of the K_{TRS} TRS resource sets and it is either predetermined or reported by the UE; and C′ is an integer value that may be either pre-determined or reported by the UE
O_{CPU}=X′_{TDCP}N_{TRS}+C″, where X″_{TDCP} is the number of CPUs required for each of the N_{TRS} TRS resources per TRS resource set and it is either predetermined or reported by the UE; and C″ is an integer value that may be either pre-determined or reported by the UE

Certain embodiments may provide one or more of the following technical advantage(s). For a given maximum number of CPUs supported by the UE, the method allows both the gNB and the UE to determine deterministically whether the UE has enough CPUs to process a TDCP report in a certain time duration. To have a limitation like this makes it possible to design a less complex UE. It puts a limit on the required CPU capabilities of the UE and thus makes it possible to dimension the UE processing power accordingly rather than to over-dimension the UE processing power for the worst case CPU load.

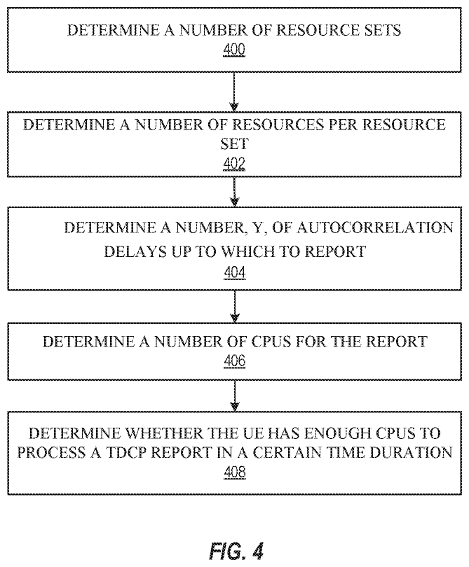

FIG. 4 illustrates a method performed by a user equipment for determining a total number of CPUs for a report in accordance with some embodiments of the present disclosure. In some embodiments, the UE determines (step 400) a number, K_{TRS}, of resource sets; determines (step 402) a number, N_{TRS}, of resources per resource set; determines (step 404) a number, Y, of autocorrelation delays up to which to report; and/or determines (step 406) a number, O_{CPU}, of CPUs for the report. In some embodiments, the UE also determines (step 408) whether the UE has enough CPUs to process a TDCP report in a certain time duration.

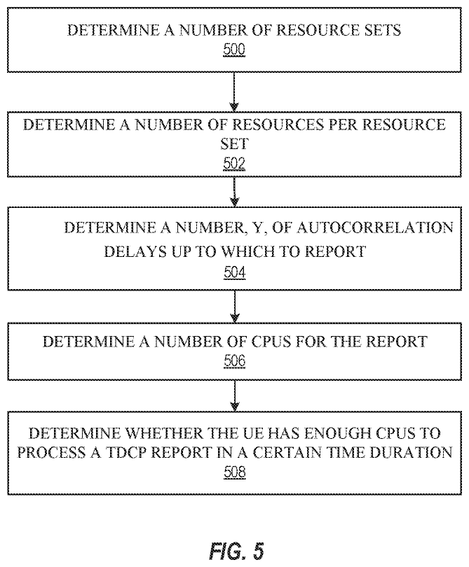

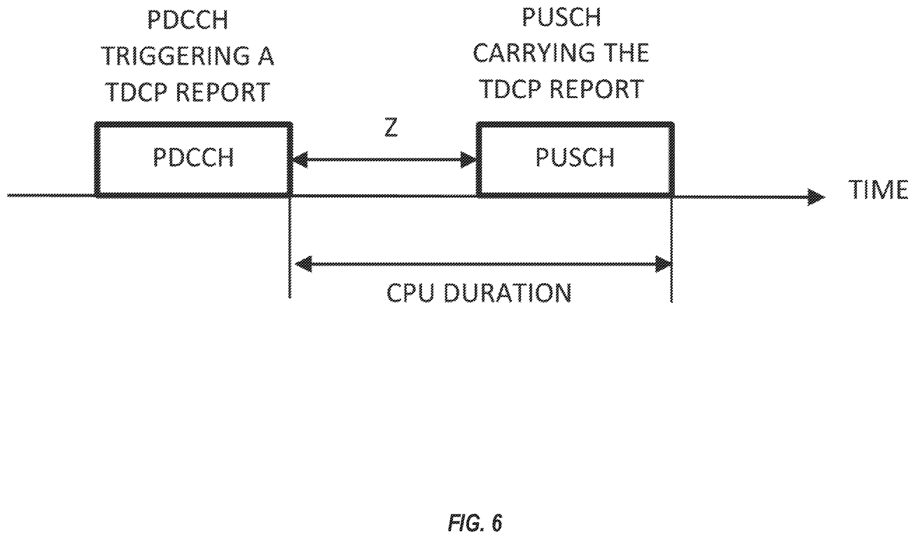

FIG. 5 illustrates the method performed by a network node for determining a total number of CPUs for a report in accordance with some embodiments of the present disclosure. In some embodiments, the network node determines (step 500) a number, K_{TRS}, of resource sets; determines (step 502) a number, N_{TRS}, of resources per resource set; determines (step 504) a number, Y, of autocorrelation delays up to which to report; and/or determines (step 506) a number, O_{CPU}, of CPUs for the report. In some embodiments, the network node also determines (step 508) whether the UE has enough CPUs to process a TDCP report in a certain time duration.

Determining the number of CPUs required for a TDCP CSI report:

In one embodiment, a UE is configured to report normalized wideband autocorrelation based TDCP report for up to Y>=1 different delay values. For instance, the candidates value of Y=4 means that the UE can compute normalized wideband autocorrelation based TDCP for up to 4 different delay values. Each of the Y TDCP computations may involve either (1) only the amplitude of the normalized wideband autocorrelation, or (2) both the amplitude and the phase of the normalized wideband autocorrelation.

A number of TRS resource sets (e.g., CSI-RS resource sets with higher layer parameter trs-info configured) configured for the UE for TDCP reporting can be up to K_{TRS}. Each of the TRS resource sets may contain up to N_{TRS} CSI-RS resources each occupying one OFDM symbol. Each TRS resource set may also be referred to as a TRS burst in this application. Each TRS resource set may contain either 2 symbols (with two CSI-RS resources) in one slot or 4 symbols (with four CSI-RS resources) in two adjacent slots.

For example, if the UE is requested to report normalized wideband autocorrelation based TDCP report for a delay value of τ=4 symbols, then this delay value is within a one slot and a single TRS resource set is sufficient for TDCP measurement.

If the UE is requested to report normalized wideband autocorrelation based TDCP report for a delay value of τ=5 slots, then this delay value is more than 2 slots and hence two different TRS resource sets separated by a delay of τ=5 slots is needed for TDCP measurement.

### Embodiment 1

In one embodiment the total number of CSI processing units (CPUs), O_{CPU}, required for processing the TDCP CSI report is determined as:

$${O}_{CPU} = {X}_{TDCP} Y$$

where X_{TDCP} is the number of CPUs required for each of the Y normalized wideband autocorrelation based TDCP computations. In one embodiment, X_{TDCP} can be a function of any one or more of the number of TRS resource sets, e.g., X_{TDCP}=ƒ(K_{TRS}), number of TRS resources per TRS resource set, e.g., X_{TDCP}=ƒ(N_{TRS}), the delay values associated with the TDCP computations (e.g., maximum delay value τₘₐₓ among the Y delay values), etc. In addition, the value of X_{TDCP} can be a function of whether only the amplitude of the normalized wideband autocorrelation is requested to be reported or both the amplitude and the phase of the normalized wideband autocorrelation is requested to be reported. For instance, if only the amplitude of the normalized wideband autocorrelation is requested to be reported, then a smaller value of X_{TDCP} may be applicable. If both the amplitude and the phase of the normalized wideband autocorrelation is requested to be reported, then a larger value of X_{TDCP} may be applicable.

In another embodiment, X_{TDCP} may be either pre-determined (e.g., defined in 3GPP specification and is known by both the gNB and the UE) or may be reported to the gNB by a UE as part of UE capability signaling.

O_{CPU} is needed at both the gNB and the UE. For a given maximum number of CPUs supported by the UE, O_{CPU} is used by the gNB to determine whether the UE has enough CPUs to process the TDCP report and thus, whether to trigger the TDCP report. If the TDCP report is triggered while the UE does not have enough CPUs, the UE would not update the TDCP report or may report a stale TDCP.

An example of CPU allocations with Y=4 and X_{TDCP}=2, O_{CPU}=4*2=8 CPUs are required for TDCP reporting.

An example of CPU allocations with Y=2 and X_{TDCP}=1, O_{CPU}=2*1=2 CPUs are required for TDCP reporting.

In an alternative form of Embodiment 1, the total number of CSI processing units (CPUs), O_{CPU}, required for processing the TDCP CSI report is determined as:

$${O}_{CPU} = {X}_{TDCP} Y + C$$

where X_{TDCP} is defined as above, and C is an integer value that may be either pre-determined (e.g., defined in 3GPP specification and is known by both the gNB and the UE) or may be reported to the gNB by a UE as part of UE capability signaling. The integer C may reflect the additional CPUs needed to calculate one or more of the amplitude and the phase of the normalized wideband autocorrelation the UE is requested to report. In some embodiments, the integer C may depend on any one or more of other factors such as the number of TRS resource sets, e.g., X_{TDCP}=ƒ(K_{TRS}), number of TRS resources per TRS resource set, e.g., X_{TDCP}=ƒ(N_{TRS}), the delay values associated with the TDCP computations (e.g., maximum delay value τₘₐₓ among the Y delay values), etc.

### Embodiment 2

In another embodiment the total number of CSI processing units (CPUs), O_{CPU}, required for processing the TDCP CSI report is determined as:

$${O}_{CPU} = {X}_{TDCP}^{′} {K}_{TRS}$$

where X′_{TDCP} is the number of CPUs required for each of the K_{TRS} TRS resource sets. In one embodiment, X′_{TDCP} can be a function of any one or more of the number of wideband autocorrelation based TDCPs the UE is configured to report, e.g., X′_{TDCP}=ƒ(Y), number of TRS resources per TRS resource set, e.g., X′_{TDCP}=ƒ(N_{TRS}), the delay values associated with the TDCP computations (e.g., maximum delay value τₘₐₓ among the Y delay values), etc. In addition, the value of X′_{TDCP} can be a function of whether only the amplitude of the normalized wideband autocorrelation is requested to be reported or both the amplitude and the phase of the normalized wideband autocorrelation is requested to be reported. For instance, if only the amplitude of the normalized wideband autocorrelation is requested to be reported, then a smaller value of X′_{TDCP} may be applicable. If both the amplitude and the phase of the normalized wideband autocorrelation is requested to be reported, then a larger value of X′_{TDCP} may be applicable.

In another embodiment, X′_{TDCP} may be either pre-determined (e.g., defined in 3GPP specification and is known by both the gNB and the UE) or may be reported to the gNB by a UE as part of UE capability signaling.

O_{CPU} is needed at both the gNB and the UE. For a given maximum number of CPUs supported by the UE, O_{CPU} is used by the gNB to determine whether the UE has enough CPUs to process the TDCP report and thus, whether to trigger the TDCP report. If the TDCP report is triggered while the UE does not have enough CPUs, the UE would not update the TDCP report or may report a staled TDCP.

An example of CPU allocations with K_{TRS}=4 and X′_{TDCP}=2, O_{CPU}=4*2=8 CPUs are required for TDCP reporting.

An example of CPU allocations with K_{TRS}=2 and X′_{TDCP}=1, O_{CPU}=2*1=2 CPUs are required for TDCP reporting.

In an alternative form of Embodiment 2, the total number of CSI processing units (CPUs), O_{CPU}, required for processing the TDCP CSI report is determined as:

$${O}_{CPU} = {X}_{TDCP}^{′} {K}_{TRS} + {C}^{′}$$

where X′_{TDCP} is defined as above, and C′ is an integer value that may be either pre-determined (e.g., defined in 3GPP specification and is known by both the gNB and the UE) or may be reported to the gNB by a UE as part of UE capability signaling. The integer C′ may reflect the additional CPUs needed to calculate one or more of the amplitude and the phase of the normalized wideband autocorrelation the UE is requested to report. In some embodiments, the integer C′ or X′_{TDCP} may depend on any one or more of other factors such as the number of wideband autocorrelation based TDCPs the UE is configured to report, e.g., X′_{TDCP}=number of TRS resources per TRS resource set, e.g., X′_{TDCP}=ƒ(N_{TRS}), the delay values associated with the TDCP computations (e.g., maximum delay value τₘₐₓ among the Y delay values), etc.

### Embodiment 3

In another embodiment the total number of CSI processing units (CPUs), O_{CPU}, required for processing the TDCP CSI report is determined as:

$${O}_{CPU} = {X}_{TDCP}^{″} {N}_{TRS}$$

where X″_{TDCP} is the number of CPUs required for each of the N_{TRS} TRS resources per TRS resource set. In one embodiment, X″_{TDCP} can be a function of any one or more of the number of wideband autocorrelation based TDCPs the UE is configured to report, e.g., X″_{TDCP}=number of TRS resource sets, e.g., X″_{TDCP}=ƒ(K_{TRS}), the delay values associated with the TDCP computations (e.g., maximum delay value τₘₐₓ among the Y delay values), etc. In addition, the value of X″_{TDCP} can be a function of whether only the amplitude of the normalized wideband autocorrelation is requested to be reported or both the amplitude and the phase of the normalized wideband autocorrelation is requested to be reported. For instance, if only the amplitude of the normalized wideband autocorrelation is requested to be reported, then a smaller value of X″_{TDCP} may be applicable. If both the amplitude and the phase of the normalized wideband autocorrelation is requested to be reported, then a larger value of X″_{TDCP} may be applicable.

In another embodiment, X″_{TDCP} may be either pre-determined (e.g., defined in 3GPP specification and is known by both the gNB and the UE) or may be reported to the gNB by a UE as part of UE capability signaling.

O_{CPU} is needed at both the gNB and the UE. For a given maximum number of CPUs supported by the UE, O_{CPU} is used by the gNB to determine whether the UE has enough CPUs to process the TDCP report and thus, whether to trigger the TDCP report. If the TDCP report is triggered while the UE doesn't have enough CPUs, the UE would not update the TDCP report or may report a staled TDCP.

An example of CPU allocations with N_{TRS}=4 and X″_{TDCP}=2, O_{CPU}=4*2=8 CPUs are required for TDCP reporting.

An example of CPU allocations with N_{TRS}=2 and X″_{TDCP}=1, O_{CPU}=2*1=2 CPUs are required for TDCP reporting.

In an alternative form of Embodiment 3, the total number of CSI processing units (CPUs), O_{CPU}, required for processing the TDCP CSI report is determined as:

$${O}_{CPU} = {X}_{TDCP}^{″} {N}_{TRS} + {C}^{″}$$

where X″_{TDCP} is defined as above, and C″ is an integer value that may be either pre-determined (e.g., defined in 3GPP specification and is known by both the gNB and the UE) or may be reported to the gNB by a UE as part of UE capability signalling. The integer C″ or X″_{TDCP} may reflect the additional CPUs needed to calculate one or more of the amplitude and the phase of the normalized wideband autocorrelation the UE is requested to reported. In some embodiments, the integer C″ or X″_{TDCP} may depend on any one or more of other factors such as the number of wideband autocorrelation based TDCPs the UE is configured to report, e.g., X′_{TDCP}=ƒ(Y), number of TRS resource sets, e.g., X″_{TDCP}=ƒ(K_{TRS}), the delay values associated with the TDCP computations (e.g., maximum delay value τₘₐₓ among the Y delay values), etc.

### Determining CPU Time Durations for a TDCP Report

For aperiodic TDCP report, the CPUs are occupied starting from the end of a PDCCH triggering the TDCP report to the last symbol of a PUSCH carrying the TDCP report. This is illustrated in FIG. 4, where Z corresponds to a delay requirement for aperiodic TDCP report and may be pre-determined or signaled by the UE as a UE capability.

In another embodiment, when periodic TRS resource sets are configured for TDCP measurement and report, the CPU(s) are occupied right after the TDCP report being configured until the TDCP report configuration is released.

Throughout the above embodiments, it is assumed that the TDCP measurements are based on TRS resources. However, the embodiments disclosed herein are non-limiting and are still applicable in case another type of reference signal is used for the measurements instead of TRS. In case another type of reference signal (e.g., NZP CSI-RS) is used instead, the following apply: the number of resources per resource set N_{TRS} will be replaced by the number of reference signals per resource set corresponding to the said type of reference signal; and the number of TRS resource sets K_{TRS} will be replaced by the number of reference signals per resource set corresponding to the said type of reference signal.

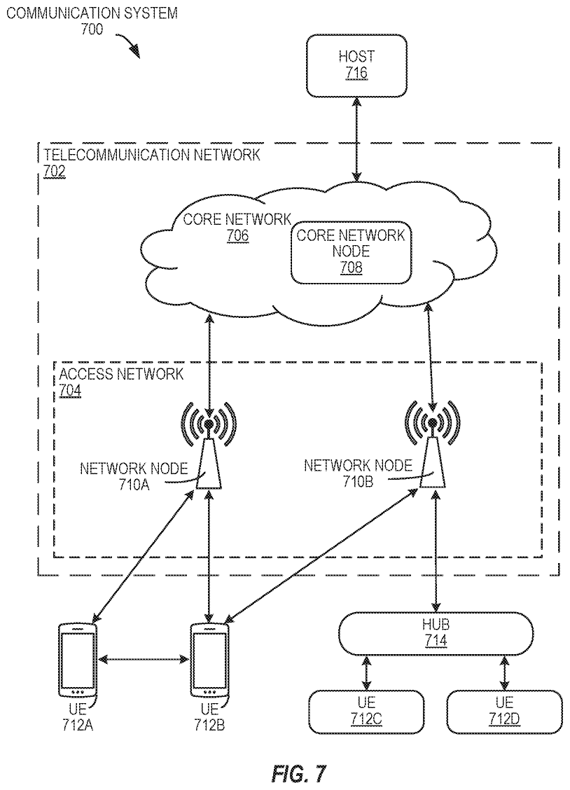

FIG. 7 shows an example of a communication system 700 in accordance with some embodiments.

In the example, the communication system 700 includes a telecommunication network 702 that includes an access network 704, such as a Radio Access Network (RAN), and a core network 706, which includes one or more core network nodes 708. The access network 704 includes one or more access network nodes, such as network nodes 710A and 710B (one or more of which may be generally referred to as network nodes 710), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 710 facilitate direct or indirect connection of User Equipment (UE), such as by connecting UEs 712A, 712B, 712C, and 712D (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702 and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system 700 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 702 is a cellular network that implements 3GPP standardized features. Accordingly, the telecommunication network 702 may support network slicing to provide different logical networks to different devices that are connected to the telecommunication network 702. For example, the telecommunication network 702 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-Radio Access Technology (RAT) or multi-standard mode. For example, a UE may operate with any one or combination of WiFi, New Radio (NR), and LTE, i.e., being configured for Multi-Radio Dual Connectivity (MR-DC), such as Evolved UMTS Terrestrial RAN (E-UTRAN) NR—Dual Connectivity (EN-DC).

In the example, a hub 714 communicates with the access network 704 to facilitate indirect communication between one or more UEs (e.g., UE 712C and/or 712D) and network nodes (e.g., network node 710B). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a Virtual Reality (VR) headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular if one or more of the UEs are low energy IoT devices.

The hub 714 may have a constant/persistent or intermittent connection to the network node 710B. The hub 714 may also allow for a different communication scheme and/or schedule between the hub 714 and UEs (e.g., UE 712C and/or 712D), and between the hub 714 and the core network 706. In other examples, the hub 714 is connected to the core network 706 and/or one or more UEs via a wired connection. Moreover, the hub 714 may be configured to connect to a Machine-to-Machine (M2M) service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710B. In other embodiments, the hub 714 may be a non-dedicated hub—that is, a device which is capable of operating to route communications between the UEs and the network node 710B, but which is additionally capable of operating as a communication start and/or end point for certain data channels.

FIG. 8 shows a UE 800 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle, vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 802 may include multiple Central Processing Units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 810 may allow the UE 800 to access instructions, application programs, and the like stored on transitory or non-transitory memory media, to off-load data, or to upload data. An article of manufacture, such as one utilizing a communication system, may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., the antenna 822) and may share circuit components, software, or firmware, or alternatively be implemented separately.

In the illustrated embodiment, communication functions of the communication interface 812 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

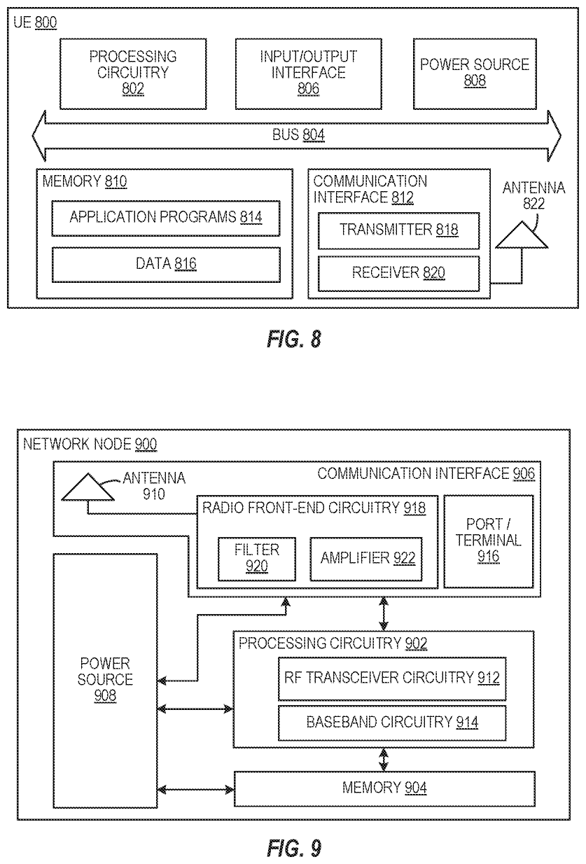

FIG. 9 shows a network node 900 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes processing circuitry 902, memory 904, a communication interface 906, and a power source 908. The network node 900 may be composed of multiple physically separate components (e.g., a NodeB component and an RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 900 may be configured to support multiple RATs. In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 900.

The processing circuitry 902 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 900 components, such as the memory 904, to provide network node 900 functionality.

In some embodiments, the processing circuitry 902 includes a System on a Chip (SOC). In some embodiments, the processing circuitry 902 includes one or more of Radio Frequency (RF) transceiver circuitry 912 and baseband processing circuitry 914. In some embodiments, the RF transceiver circuitry 912 and the baseband processing circuitry 914 may be on separate chips (or sets of chips), boards, or units, such as radio units and digital units. In alternative embodiments, part or all of the RF transceiver circuitry 912 and the baseband processing circuitry 914 may be on the same chip or set of chips, boards, or units.

The memory 904 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and the memory 904 are integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. The radio front-end circuitry 918 comprises filters 920 and amplifiers 922. The radio front-end circuitry 918 may be connected to the antenna 910 and the processing circuitry 902. The radio front-end circuitry 918 may be configured to condition signals communicated between the antenna 910 and the processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of the filters 920 and/or the amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface 906 may comprise different components and/or different combinations of components.

In certain alternative embodiments, the network node 900 does not include separate radio front-end circuitry 918; instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes the one or more ports or terminals 916, the radio front-end circuitry 918, and the RF transceiver circuitry 912 as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, the communication interface 906, and/or the processing circuitry 902 may be configured to perform any receiving operations and/or certain obtaining operations described herein as being performed by the network node 900. Any information, data, and/or signals may be received from a UE, another network node, and/or any other network equipment. Similarly, the antenna 910, the communication interface 906, and/or the processing circuitry 902 may be configured to perform any transmitting operations described herein as being performed by the network node 900. Any information, data, and/or signals may be transmitted to a UE, another network node, and/or any other network equipment.

The power source 908 provides power to the various components of the network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid or an electricity outlet) via input circuitry or an interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

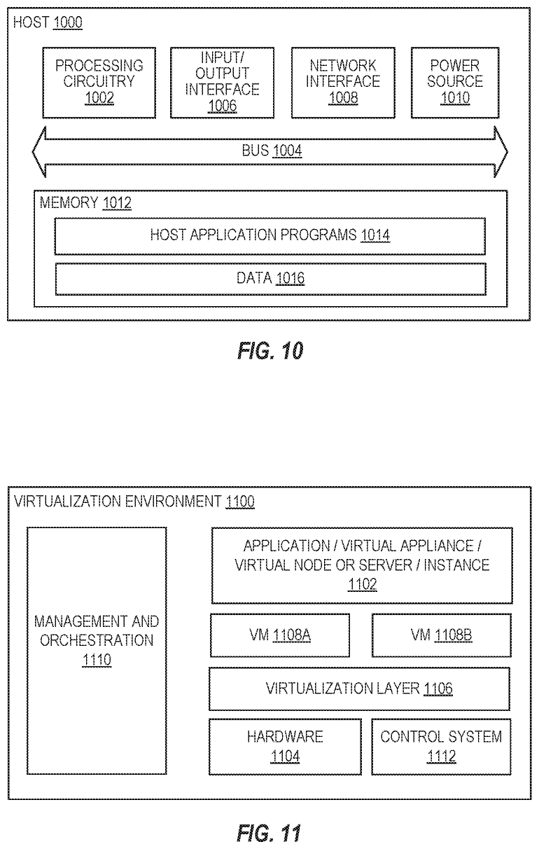

FIG. 10 is a block diagram of a host 1000, which may be an embodiment of the host 716 of FIG. 7, in accordance with various aspects described herein. As used herein, the host 1000 may be or comprise various combinations of hardware and/or software including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and memory 1012. Other components may be included in other embodiments. Features of these components may be substantially similar to those described with respect to the devices of previous figures, such as FIGS. 8 and 9, such that the descriptions thereof are generally applicable to the corresponding components of the host 1000.

The memory 1012 may include one or more computer programs including one or more host application programs 1014 and data 1016, which may include user data, e.g. data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for Over-The-Top (OTT) services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or VM Monitors (VMMs)), provide VMs 1108A and 1108B (one or more of which may be generally referred to as VMs 1108), and/or perform any of the functions, features, and/or benefits described in relation with some embodiments described herein. The virtualization layer 1106 may present a virtual operating platform that appears like networking hardware to the VMs 1108.

The VMs 1108 comprise virtual processing, virtual memory, virtual networking, or interface and virtual storage, and may be run by a corresponding virtualization layer 1106. Different embodiments of the instance of a virtual appliance 1102 may be implemented on one or more of the VMs 1108, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1108 may be a software implementation of a physical machine that runs programs as if they were executing on a physical, non-virtualized machine. Each of the VMs 1108, and that part of the hardware 1104 that executes that VM, be it hardware dedicated to that VM and/or hardware shared by that VM with others of the VMs 1108, forms separate virtual network elements. Still in the context of NFV, a virtual network function is responsible for handling specific network functions that run in one or more VMs 1108 on top of the hardware 1104 and corresponds to the application 1102.

The hardware 1104 may be implemented in a standalone network node with generic or specific components. The hardware 1104 may implement some functions via virtualization. Alternatively, the hardware 1104 may be part of a larger cluster of hardware (e.g., such as in a data center or CPE) where many hardware nodes work together and are managed via management and orchestration 1110, which, among others, oversees lifecycle management of the applications 1102. In some embodiments, the hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 1112 which may alternatively be used for communication between hardware nodes and radio units.

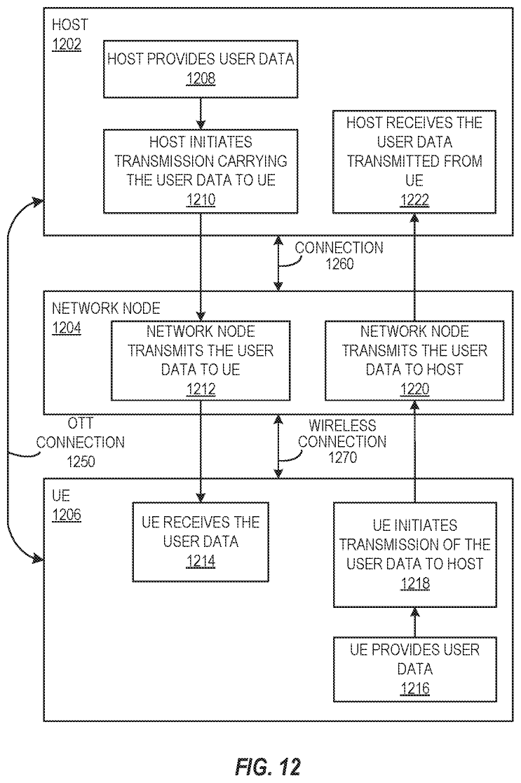

FIG. 12 shows a communication diagram of a host 1202 communicating via a network node 1204 with a UE 1206 over a partially wireless connection in accordance with some embodiments. Example implementations, in accordance with various embodiments, of the UE (such as the UE 712A of FIG. 7 and/or the UE 800 of FIG. 8), the network node (such as the network node 710A of FIG. 7 and/or the network node 900 of FIG. 9), and the host (such as the host 716 of FIG. 7 and/or the host 1000 of FIG. 10) discussed in the preceding paragraphs will now be described with reference to FIG. 12.

Like the host 1000, embodiments of the host 1202 include hardware, such as a communication interface, processing circuitry, and memory. The host 1202 also includes software, which is stored in or is accessible by the host 1202 and executable by the processing circuitry. The software includes a host application that may be operable to provide a service to a remote user, such as the UE 1206 connecting via an OTT connection 1250 extending between the UE 1206 and the host 1202. In providing the service to the remote user, a host application may provide user data which is transmitted using the OTT connection 1250.

The network node 1204 includes hardware enabling it to communicate with the host 1202 and the UE 1206. The connection 1260 may be direct or pass through a core network (like the core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by the UE 1206 and executable by the UE's processing circuitry. The software includes a client application, such as a web browser or operator-specific “app” that may be operable to provide a service to a human or non-human user via the UE 1206 with the support of the host 1202. In the host 1202, an executing host application may communicate with the executing client application via the OTT connection 1250 terminating at the UE 1206 and the host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via the connection 1260 between the host 1202 and the network node 1204 and via a wireless connection 1270 between the network node 1204 and the UE 1206 to provide the connection between the host 1202 and the UE 1206. The connection 1260 and the wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204 in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR, or AR which it can broadcast, multicast, or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1250 between the host 1202 and the UE 1206 in response to variations in the measurement results. The measurement procedure and/or the network functionality for reconfiguring the OTT connection 1250 may be implemented in software and hardware of the host 1202 and/or the UE 1206. In some embodiments, sensors (not shown) may be deployed in or in association with other devices through which the OTT connection 1250 passes; the sensors may participate in the measurement procedure by supplying values of the monitored quantities exemplified above, or by supplying values of other physical quantities from which software may compute or estimate the monitored quantities. The reconfiguring of the OTT connection 1250 may include message format, retransmission settings, preferred routing, etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency, and the like by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

### EMBODIMENTS

### Group A Embodiments

Embodiment 1: A method performed by a user equipment for determining a total number of CPUs for a report, the method comprising one or more of: determining (400) a number, K_{TRS}, of resource sets; determining (402) a number, N_{TRS}, of resources per resource set; determining (404) a number, Y, of autocorrelation delays up to which to report; and determining (406) a number, O_{CPU}, of CPUs for the report.

Embodiment 2: The method of the previous embodiment wherein one or more of: the report comprises a Time Domain Channel Property, TDCP, report; the resource sets comprise Tracking Reference Signal, TRS, resource sets; and the resources comprise TRS resources.

Embodiment 3: The method of the previous embodiments wherein determining the number, O_{CPU}, of CPUs for the report comprises: O_{CPU}=X_{TDCP}Y+C, where X_{TDCP} is the number of CPUs required for each of the Y normalized wideband autocorrelation based TDCP computations.

Embodiment 4: The method of the previous embodiments wherein X_{TDCP} is either predetermined or reported by the UE.

Embodiment 5: The method of the previous embodiments wherein the value of X_{TDCP} is a function of whether only the amplitude of the normalized wideband autocorrelation is requested to be reported or both the amplitude and the phase of the normalized wideband autocorrelation is requested to be reported.

Embodiment 6: The method of the previous embodiments wherein C is an integer value that is either pre-determined or reported by the UE.

Embodiment 7: The method of the previous embodiments wherein determining the number, O_{CPU}, of CPUs for the report comprises: O_{CPU}=X′_{TDCP}K_{TRS}+C′, where X′_{TDCP} is the number of CPUs required for each of the K_{TRS} TRS resource sets.

Embodiment 8: The method of the previous embodiments wherein X′_{TDCP} is either predetermined or reported by the UE.

Embodiment 9: The method of the previous embodiments wherein the value of X′_{TDCP} is a function of whether only the amplitude of the normalized wideband autocorrelation is requested to be reported or both the amplitude and the phase of the normalized wideband autocorrelation is requested to be reported.

Embodiment 10: The method of the previous embodiments wherein C′ is an integer value that is either pre-determined or reported by the UE.

Embodiment 11: The method of the previous embodiments wherein determining the number, O_{CPU}, of CPUs for the report comprises: O_{CPU}=X_{TDCP}N_{TRS}+C″, where X″_{TDCP} is the number of CPUs required for each of the N_{TRS} TRS resources per TRS resource set.

Embodiment 12: The method of the previous embodiments wherein X″_{TDCP} is either predetermined or reported by the UE.

Embodiment 13: The method of the previous embodiments wherein the value of X″_{TDCP} is a function of whether only the amplitude of the normalized wideband autocorrelation is requested to be reported or both the amplitude and the phase of the normalized wideband autocorrelation is requested to be reported.

Embodiment 14: The method of the previous embodiments wherein C″ is an integer value that is either pre-determined or reported by the UE.

Embodiment 15: The method of the previous embodiments further comprising: determining (408) whether the UE has enough CPUs to process a TDCP report in a certain time duration.

Embodiment 16: The method of the previous embodiments wherein the UE is configured to report normalized wideband autocorrelation based TDCP report for up to Y>=1 different delay values.

Embodiment 17: The method of the previous embodiments wherein X_{TDCP} is a function of any one or more of: the number of TRS resource sets, e.g., X_{TDCP}=ƒ(K_{TRS}); the number of TRS resources per TRS resource set (e.g., X_{TDCP}=ƒ(N_{TRS})); the delay values associated with the TDCP computations (e.g., maximum delay value τₘₐₓ among the Y delay values).

Embodiment 18: The method of the previous embodiments wherein O_{CPU}=1 if the Y normalized wideband autocorrelations are for delays within 2 slots regardless the value of Y.

Embodiment 19: The method of the previous embodiments wherein O_{CPU}=X_{TDCP}Y only if the Y normalized wideband autocorrelations are for delays larger than or equal to 2 slots.

Embodiment 20: The method of the previous embodiments wherein X_{TDCP} is either pre-determined (e.g., defined in 3gpp specification and is known by both the gNB and the UE) or may be reported to the gNB by a UE as part of UE capability signaling.

Embodiment 21: The method of the previous embodiments wherein, when periodic TRS resource sets are configured for TDCP measurement and report, the CPU(s) are occupied right after the TDCP report being configured until the TDCP report configuration is released.

Embodiment 22: The method of the previous embodiments wherein the TDCP measurements are based on TRS resources.

Embodiment 23: The method of the previous embodiments wherein the TDCP measurements are based on another type of reference signal (e.g., NZP CSI-RS).

Embodiment 24: The method of the previous embodiments wherein the number of resources per resource set N_{TRS} will be replaced by the number of reference signals per resource set corresponding to the said type of reference signal.

Embodiment 25: The method of the previous embodiments wherein the number of TRS resource sets K_{TRS} will be replaced by the number of reference signals per resource set corresponding to the said type of reference signal.

Embodiment 26: The method of any of the previous embodiments, further comprising: providing user data; and forwarding the user data to a host via the transmission to the network node.

### Group B Embodiments

Embodiment 27: A method performed by a network node for determining a total number of CPUs for a report, the method comprising one or more of: determining (500) a number, K_{TRS}, of resource sets; determining (502) a number, N_{TRS}, of resources per resource set; determining (504) a number, Y, of autocorrelation delays up to which to report; and determining (506) a number, O_{CPU}, of CPUs for the report.

Embodiment 28: The method of the previous embodiment wherein one or more of: the report comprises a Time Domain Channel Property, TDCP, report; the resource sets comprise Tracking Reference Signal, TRS, resource sets; and the resources comprise TRS resources.

Embodiment 29: The method of the previous embodiments wherein determining the number, O_{CPU}, of CPUs for the report comprises: O_{CPU}=X_{TDCP}Y+C, where X_{TDCP} is the number of CPUs required for each of the Y normalized wideband autocorrelation based TDCP computations.

Embodiment 30: The method of the previous embodiments wherein X_{TDCP} is either predetermined or reported by the UE.

Embodiment 31: The method of the previous embodiments wherein the value of X_{TDCP} is a function of whether only the amplitude of the normalized wideband autocorrelation is requested to be reported or both the amplitude and the phase of the normalized wideband autocorrelation is requested to be reported.

Embodiment 32: The method of the previous embodiments wherein C is an integer value that is either pre-determined or reported by the UE.

Embodiment 33: The method of the previous embodiments wherein determining the number, O_{CPU}, of CPUs for the report comprises: O_{CPU}=X′_{TDCP}K_{TRS}+C′, where X′_{TDCP} is the number of CPUs required for each of the K_{TRS} TRS resource sets.

Embodiment 34: The method of the previous embodiments wherein X′_{TDCP} is either predetermined or reported by the UE.

Embodiment 35: The method of the previous embodiments wherein the value of X′_{TDCP} is a function of whether only the amplitude of the normalized wideband autocorrelation is requested to be reported or both the amplitude and the phase of the normalized wideband autocorrelation is requested to be reported.

Embodiment 36: The method of the previous embodiments wherein C′ is an integer value that is either pre-determined or reported by the UE.

Embodiment 37: The method of the previous embodiments wherein determining the number, O_{CPU}, of CPUs for the report comprises: O_{CPU}=X″_{TDCP}N_{TRS}+C″, where X″_{TDCP} is the number of CPUs required for each of the N_{TRS} TRS resources per TRS resource set.

Embodiment 38: The method of the previous embodiments wherein X″_{TDCP} is either predetermined or reported by the UE.

Embodiment 39: The method of the previous embodiments wherein the value of X″_{TDCP} is a function of whether only the amplitude of the normalized wideband autocorrelation is requested to be reported or both the amplitude and the phase of the normalized wideband autocorrelation is requested to be reported.

Embodiment 40: The method of the previous embodiments wherein C″ is an integer value that is either pre-determined or reported by the UE.

Embodiment 41: The method of the previous embodiments further comprising: determining (508) whether the UE has enough CPUs to process a TDCP report in a certain time duration.

Embodiment 42: The method of the previous embodiments wherein the UE is configured to report normalized wideband autocorrelation based TDCP report for up to Y>=1 different delay values.

Embodiment 43: The method of the previous embodiments wherein X_{TDCP} is a function of any one or more of: the number of TRS resource sets, e.g., X_{TDCP}=ƒ(K_{TRS}); the number of TRS resources per TRS resource set (e.g., X_{TDCP}=ƒ(N_{TRS})); the delay values associated with the TDCP computations (e.g., maximum delay value τₘₐₓ among the Y delay values).

Embodiment 44: The method of the previous embodiments wherein O_{CPU}=1 if the Y normalized wideband autocorrelations are for delays within 2 slots regardless the value of Y.

Embodiment 45: The method of the previous embodiments wherein O_{CPU}=X_{TDCP}Y only if the Y normalized wideband autocorrelations are for delays larger than or equal to 2 slots.

Embodiment 46: The method of the previous embodiments wherein X_{TDCP} is either pre-determined (e.g., defined in 3gpp specification and is known by both the gNB and the UE) or may be reported to the gNB by a UE as part of UE capability signaling.

Embodiment 47: The method of the previous embodiments wherein, when periodic TRS resource sets are configured for TDCP measurement and report, the CPU(s) are occupied right after the TDCP report being configured until the TDCP report configuration is released.

Embodiment 48: The method of the previous embodiments wherein the TDCP measurements are based on TRS resources.

Embodiment 49: The method of the previous embodiments wherein the TDCP measurements are based on another type of reference signal (e.g., NZP CSI-RS).

Embodiment 50: The method of the previous embodiments wherein the number of resources per resource set N_{TRS} will be replaced by the number of reference signals per resource set corresponding to the said type of reference signal.

Embodiment 51: The method of the previous embodiments wherein the number of TRS resource sets K_{TRS} will be replaced by the number of reference signals per resource set corresponding to the said type of reference signal.

Embodiment 52: The method of any of the previous embodiments, further comprising: obtaining user data; and forwarding the user data to a host or a user equipment.

### Group C Embodiments

Embodiment 53: A user equipment for determining a total number of CPUs, comprising: processing circuitry configured to perform any of the steps of any of the Group A embodiments; and power supply circuitry configured to supply power to the processing circuitry.

Embodiment 54: A network node for determining a total number of CPUs, the network node comprising: processing circuitry configured to perform any of the steps of any of the Group B embodiments; and power supply circuitry configured to supply power to the processing circuitry.

Embodiment 55: A user equipment (UE) for determining a total number of CPUs, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 56: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 57: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 58: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 59: The method of the previous embodiment, further comprising, at the network node, transmitting the user data provided by the host for the UE.

Embodiment 60: The method of any of the previous 2 embodiments, wherein the user data is provided at the host by executing a host application that interacts with a client application executing on the UE, the client application being associated with the host application.

Embodiment 61: A communication system configured to provide an over-the-top (OTT) service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 62: The communication system of the previous embodiment, further comprising: the network node; and/or the UE.

Embodiment 63: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 64: The host of the previous 2 embodiments, wherein: the processing circuitry of the host is configured to execute a host application that receives the user data; and the host application is configured to interact with a client application executing on the UE, the client application being associated with the host application.

Embodiment 65: The host of the any of the previous 2 embodiments, wherein the initiating receipt of the user data comprises requesting the user data.

Embodiment 66: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 67: The method of the previous embodiment, further comprising at the network node, transmitting the received user data to the host.

Embodiment 68: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.

Embodiment 69: The host of the previous embodiment, wherein the cellular network further includes a network node configured to communicate with the UE to transmit the user data to the UE from the host.

Embodiment 69: The host of the previous 2 embodiments, wherein: the processing circuitry of the host is configured to execute a host application, thereby providing the user data; and the host application is configured to interact with a client application executing on the UE, the client application being associated with the host application.

Embodiment 70: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 71: The method of the previous embodiment, further comprising: at the host, executing a host application associated with a client application executing on the UE to receive the user data from the host application.

Embodiment 72: The method of the previous embodiment, further comprising: at the host, transmitting input data to the client application executing on the UE, the input data being provided by executing the host application, wherein the user data is provided by the client application in response to the input data from the host application.

Embodiment 73: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 74: The host of the previous embodiment, wherein the cellular network further includes a network node configured to communicate with the UE to transmit the user data from the UE to the host.

Embodiment 75: The host of the previous 2 embodiments, wherein: the processing circuitry of the host is configured to execute a host application, thereby providing the user data; and the host application is configured to interact with a client application executing on the UE, the client application being associated with the host application.

Embodiment 76: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 77: The method of the previous embodiment, further comprising: at the host, executing a host application associated with a client application executing on the UE to receive the user data from the UE.

Embodiment 78: The method of the previous 2 embodiments, further comprising: at the host, transmitting input data to the client application executing on the UE, the input data being provided by executing the host application, wherein the user data is provided by the client application in response to the input data from the host application.

Those skilled in the art will recognize improvements and modifications to the embodiments of the present disclosure. All such improvements and modifications are considered within the scope of the concepts disclosed herein.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method performed by a User Equipment (UE) for determining a total number of Channel State Information (CSI) Processing Units (CPUs) for a report, the method comprising:
determining a number (Y) of autocorrelation delays up to which to report; and
determining a number (O_{CPU}) of CPUs for the report, based on the number (Y) of autocorrelation delays up to which to report;
wherein determining the number (O_{CPU}) of CPUs for the report comprises:
O_{CPU}=X_{TDCP}Y+C, where X_{TDCP} is the number of CPUs required for each of the Y normalized wideband autocorrelation based TDCP computations.

2. The method of claim 1 wherein the report comprises a Time Domain Channel Property (TDCP) report.

3. The method of claim 1, wherein the TDCP report comprises the Y normalized wideband autocorrelation based TDCP computations each of which corresponding to each of the Y autocorrelation delays.

4. (canceled)

5. The method of claim 1, wherein X_{TDCP} is reported by the UE.

6. The method of claim 1, wherein the value of X_{TDCP} is a function of whether only the amplitude of the normalized wideband autocorrelation is requested to be reported or both the amplitude and the phase of the normalized wideband autocorrelation is requested to be reported.

7. The method of claim 1, wherein C is an integer value that is reported by the UE.

8-11. (canceled)

12. The method of claim 1, further comprising:
determining whether the UE has enough CPUs to process a TDCP report in a certain time duration.

13. The method of claim 1, wherein the UE is configured to report normalized wideband autocorrelation based TDCP report for up to Y>=1 different delay values.

14. The method of claim 1, wherein X_{TDCP} is a function of any one or more of:
the number of TRS resource sets;
the number of TRS resources per TRS resource set; and
the delay values associated with the TDCP computations.

15. The method of claim 1, wherein O_{CPU}=1 if the Y normalized wideband autocorrelations are for delays within 2 slots regardless the value of Y.

16. The method of claim 1, wherein, when periodic TRS resource sets are configured for TDCP measurement and report, the CPU(s) are occupied right after the TDCP report being configured until the TDCP report configuration is released.

17. The method of claim 1, wherein the TDCP measurements are based on TRS resources.

18. The method of claim 1, wherein the TDCP measurements are based on another type of reference signal.

19. The method of claim 1, wherein the number of resources per resource set N_{TRS} is replaced by the number of reference signals per resource set corresponding to the said type of reference signal.

20. The method of claim 1, wherein the number of TRS resource sets K_{TRS} is replaced by the number of reference signals per resource set corresponding to the said type of reference signal.

21. A method performed by a network node for determining a total number of Channel State Information (CSI) Processing Units, (CPUs) for a report, the method comprising:
determining a number (Y) of autocorrelation delays up to which to report; and
determining a number (O_{CPU}) of CPUs for the report based on the number (Y) of autocorrelation delays up to which to report;
wherein determining the number (O_{CPU}) of CPUs for the report comprises:
O_{CPU}=X_{TDCP}Y+C, where X_{TDCP} is the number of CPUs required for each of the Y normalized wideband autocorrelation based TDCP computations.

22. The method of claim 21, wherein the report comprises a Time Domain Channel Property (TDCP) report.

23. The method of claim 21, wherein the TDCP report comprises the Y normalized wideband autocorrelation based TDCP computations each of which corresponding to each of the Y autocorrelation delays.

24-40. (canceled)

41. A User Equipment (UE) for determining a total number of Channel State Information (CSI) Processing Units (CPUs) for a report, the UE comprising processing circuitry and memory, the memory comprising instructions to cause the UE to:
determine a number (Y) of autocorrelation delays up to which to report; and
determine a number (O_{CPU}) of CPUs for the report, based on the number (Y) of autocorrelation delays up to which to report;
wherein the number (O_{CPU}) of CPUs for the report is determined based on:
O_{CPU}=X_{TDCP}Y+C, where X_{TDCP} is the number of CPUs required for each of the Y normalized wideband autocorrelation based TDCP computations.

42-46. (canceled)
